(19) United States
(12) Patent Application Publication
(10) Pub. No.: US 2025/0353744 A1
(43) Pub. Date: Nov. 20, 2025

(54) Solvent-Free, Low Temperature Synthesis of Sulfide-type Sodium-Ion Conductors

(71) Applicant: UNIVERSITY OF LOUISVILLE RESEARCH FOUNDATION, INC., Louisville, KY (US)

(72) Inventors: Hui Wang, Louisville, KY (US); Badri Narayanana,, Louisville, KY (US); Selim Halacoglu,, Weymouth, MA (US)

(21) Appl. No.: 19/208,129

(22) Filed: May 14, 2025

Related U.S. Application Data
(60) Provisional application No. 63/649,040, filed on May 17, 2024.

(51) Int. Cl. C01B 17/34; H01M 10/0562

(52) U.S. Cl. CPC C01B 17/34; H01M 10/0562; C01P 2002/72; C01P 2002/82; C01P 2002/85; C01P 2002/88; C01P 2004/03; C01P 2004/04; C01P 2006/40; H01M 2300/008

(57) ABSTRACT

Solvent-free methods are provided for synthesizing NSS ionic conductors including but not limited to Se-doped and fluorine-doped NSS ionic conductors, which can be used as solid electrolytes in electrochemical storage devices and providing high ionic conductivity at room temperature and other advantages.

### CROSS-REFERENCE TO RELATED APPLICATIONS

This patent application claims the benefit of and priority to U.S. Provisional Patent Application Ser. No. 63/649,040 with a filing date of May 17, 2024, the contents of which are fully incorporated herein by reference.

### STATEMENT OF GOVERNMENT INTEREST

This invention was made with government support under DE-SC0021257 awarded by the U.S. Department of Energy. The government has certain rights in the invention.

### FIELD OF INVENTION

Methods are provided for synthesis of novel chalcogenide and halide-doped sulfide solid electrolytes (SEs), in which the methods are characterized by an environmentally friendly, solvent-free approach; precise and flexible composition control; and manufacturing efficiency, offering beneficial applications and uses for a broad range of solid-state Na metal batteries.

### BACKGROUND

All-solid-state batteries based on nonflammable solid conductors in place of organic liquid electrolytes have attracted significant attention due to their promising features of high energy density, ionic conductivity including at room temperature, low activation energy, longer lifespan, and enhanced safety.

Sodium chalcogenide ionic conductors are attractive candidates as SEs in solid-state Na metal batteries. Compared with expensive lithium (Li) compounds, rechargeable sodium (Na) batteries show more promise from a number of perspectives, including medium- to large-scale storage system and economic considerations.

While chalcogenides such as Na₃PS₄, Cl-doped Na₃PS₄, and Se-substituted Na₃PSe₄ are among the inorganic Na-ion conductors that have been explored, the development of efficient and scalable synthesis approaches has been challenging. Na₃SbS₄ is another example of a sulfide-based SE, which like Na₃PS₄ exhibits a phase transition from the tetragonal crystal structure to the more Na-ion conductive cubic crystal structure. The Sb-containing chalcogenide SE tends to show greater ionic conductivity than the P-containing chalcogenide SE due to the larger atomic size of Sb compared to P.

As one example, Na₃SbS₄ exhibits a conductive mechanism featuring Na ion transport through 3D tunnels formed by alternating and face-sharing NaS₆ octahedron and NaS₈ dodecahedron. While notable, the functional performance of Na₃SbS₄ and thus its prospects for practical use still are wanting for improvement. Various approaches with doping chemistry have provided some improvements in the ionic conductivity of Na₃SbS₄. These approaches include aliovalent doping with tungsten (W) at Sb⁵⁺ sites, and, as previously mentioned, Se substitution of S. For example, the tetragonal-to-cubic phase transition as well as a significant change of Sb—S bonding in Raman spectra have been observed with heavy Se-doping in Na₃SbS₄. However, synthesis of these inorganic compounds has proven inefficient and costly to date.

Various synthesis approaches have been tried in an attempt to find efficient, low-temperature production of the chalcogenides discussed herein. These include high-temperature (approximately) 450-800° C. solid-state reaction with extensive ball-milling treatment, and a thermal decomposition process. It is known in the relevant field that syntheses conducted under such higher temperatures produce chalcogenides with good functional properties as SEs. On the other hand, lower temperatures are desirable, but prior attempts have either not provided chalcogenides with acceptable functional properties or have been marked by similar kinds of problems as high-temperature approaches, or both.

For example, liquid-based synthetic approaches also have been used to produce Na₃SbS₄, along with halide-doped conductors, by mixing precursors in a liquid medium (e.g. deionized water, methanol), followed by low-temperature heating treatment (≤200° C.). Even so, these approaches have drawbacks that make them less practical, based on the higher temperatures used and the need for solvents. Moreover, the results of these solvent-based approaches have been marked by lower crystallinity and relatively lower ion conductivities, requiring post-heating treatment at high temperature which may or may not provide the necessary conductivity, energy density, and lifespan.

Accordingly, a solvent-free and low-temperature synthesis approach for Na chalcogenides that exhibit the previously mentioned features related to high energy density, ionic conductivity, low activation energy, longer lifespan, and enhanced safety would provide significant advantages for their use as SEs in rechargeable sodium (Na) batteries. As discussed below, the chalcogenides of the present embodiments provide these and other advantages, including higher ionic conductivity at room temperature and greater chemical stability in air, making them an attractive option for use as SEs in solid-state Na metal batteries.

Besides the chalcogenides mentioned above, various dopants have been investigated in an effort to enhance ionic conductivity. These include, for example, Na_{2.88}Sb_{0.88}Mo_{0.12}S₄, Na_{3.3}Zn_{0.1}Sb_{0.9}S₄, Na_{3.1}Ge_{0.1}Sb_{0.9}S₄, Na_{2.88}Sb_{0.88}W_{0.12}S₄ which were found to display higher ionic conductivities and favorable activation energies.

In addition, halide dopants such as Cl⁻, Br⁻, and I⁻ have been investigated to partially substitute S for improved electrochemical stability in sulfide-based, sodium-containing SEs for electrochemical storage devices. Approaches used for these halide doped conductors have included, for example, solid-state reactions at temperatures above 450° C., solvent-based approaches, and solvent-free techniques. Even so, with conventional approaches for both sodium chalcogenide syntheses generally and halide doping in particular, various challenges exist with respect to the need for melt quenching, high energy ball milling, solvents, and other harsh as well as expensive processing conditions.

Moreover, studies have been limited with respect to introduction of fluorine and other halides into these crystalline structures for their use as inorganic solid-state ionic conductors, as well as the effects on ion conduction when these halide-incorporated sulfide-type SEs undergo post-heating treatment wherein halogen atoms replace a like number of S atoms in the crystalline structure of the NSS ionic conductors (sometimes referred to herein as “ionic conductors;” “NSS conductors;” and “sulfide-type sodium-ion conductors”). Accordingly, additional embodiments described herein include solvent-free and low-temperature syntheses of halide doped Na chalcogenides, which also exhibit the previously mentioned features related to high energy density, ionic conductivity, low activation energy, longer lifespan, and enhanced safety for use as SEs in rechargeable sodium (Na) batteries.

### SUMMARY OF EMBODIMENTS

Embodiments of the present disclosure are directed to various solid-ion conductors using low-temperature, solvent-free methods of synthesis. In one aspect, superionic conductors are provided, comprising crystalline Na₃SbS_{4-y}Se_{y} chalcogenides with compositional flexibility which can be used as SE's for use in solid-state Na batteries. Alternative methods of synthesis include performing the synthesis reaction at a relatively low temperature, e.g., in some embodiments about 150° C., which is lower compared to conventional synthesis methods. This approach may be accompanied by use of low vacuum (10⁻³ torr). Another optional method disclosed herein is to perform electron beam-assisted synthesis under high vacuum (10⁻⁶ torr) in a transmission electron microscopy (TEM) chamber to achieve the same products.

In still other aspects, the SEs comprise Na₃SbS₄ nanocomposites with varying concentration of fluorine (F) using the low-temperature (e.g., 150° C.) heating approach in the synthesis reaction, without use of vacuum or electron beam. In this approach, post-synthesis heating (referred to herein as “post-heating” or “post-heating treatment”) occurs at a higher temperature, e.g., 300° C. followed by cooling. As described herein, post-heating treatment at 300° C. demonstrated increased ionic conductivity of halide-doped xNaX·(1−x) Na₃SbS₄ nanocomposites with various halide contents, including where X is either F, Cl, Br, or I. By the synthesis methods provided for herein, xNaX·(1−x) Na₃SbS₄ nanocomposites at varying halide levels (including but not limited to F) showed improved conductivity, electrochemical stability, and stable cycling compared to pristine Na₃SbS₄ (sometimes referred to herein as “NSS”).

### BRIEF DESCRIPTION OF THE FIGURES

The patent or application file with respect to the present disclosure contains at least one drawing executed in color. Copies of this patent or patent application publication with color drawing(s) will be provided by the Office upon request and payment of the necessary fee.

The drawings, schematics, figures, and descriptions herein are to be understood as illustrative of structures, features and aspects of the present embodiments and do not limit the scope of the embodiments solely as a result of their inclusion in the Figures. Likewise, the scope of the application is not limited to any precise arrangements, scales, or dimensions as shown in the Figures, nor as discussed in the textual descriptions.

FIG. 1A shows X-ray diffraction (XRD) patterns for crystalline Na₃SbS_{4-y}Se_{y} chalcogenides formed by a synthesis according to multiple embodiments and alternatives.

FIG. 1B shows thermal gravimetric analysis (TGA) curves for three Na₃SbS_{4-y}Se_{y} intermediate hydrates obtained during syntheses according to multiple embodiments and alternatives.

FIG. 2 provides selected area electron diffraction (SAED) patterns for Na₃SbS_{4-y}Se_{y} chalcogenides synthesized by electron-beam assisted methods with and without additional heat treatment, according to multiple embodiments and alternatives.

FIG. 3A shows the results of SAED of Na₃SbS₄ at 400° C.

FIG. 3B shows the results of SAED of Na₃SbS₃Se at 400° C.

FIG. 4A and FIG. 4B show scanning electron microscope (SEM) images of Na₃SbS_{4-y}Se_{y} chalcogenides synthesized according to multiple embodiments and alternatives.

FIG. 4C provides EDS images from elemental mapping of Na₃SbS₃Se electrolyte synthesized according to multiple embodiments and alternatives, specific for Na, Sb, S, and Se.

FIG. 5A and FIG. 5B display Raman spectra of Na₃SbS_{4-y}Se_{y} chalcogenides synthesized according to multiple embodiments and alternatives.

FIG. 5C graphs ionic conductivities as determined for several Na₃SbS_{4-y}Se_{y} chalcogenides synthesized according to multiple embodiments and alternatives.

FIG. 5D provides Arrhenius plots within a temperature range of 30-110° C. for Na₃SbS_{4-y}Se_{y} chalcogenides synthesized at room temperature according to multiple embodiments and alternatives.

FIG. 5E shows Nyquist plots at room temperature for Na₃SbS_{4-y}Se_{y} chalcogenides synthesized according to multiple embodiments and alternatives.

FIG. 6A provides polarization voltage profiles for Na|SE|Na symmetric cells under a current density of 0.1 mA cm⁻², for the SEs Na₃SbS₄ and Na₃SbS₃Se synthesized according to multiple embodiments and alternatives.

FIG. 6B shows Nyquist plots of the Na|Na₃SbS₃Se|Na cell of FIG. 6A after cycling over different time frames.

FIG. 6C provides the equivalent circuit for the Na|Na₃SbS₃Se|Na cell of FIG. 6B.

FIG. 6D and FIG. 6E, respectively, plot Na grand potential phase stability for Na₃SbS_{4-y}Se_{y} chalcogenides (y=0, 1) synthesized according to multiple embodiments and alternatives.

FIG. 7A shows charge-discharge profiles of a FeS₂|SE|Na over 100 cycles, where SE is Na₃SbS₃Se synthesized according to multiple embodiments and alternatives.

FIG. 7B shows electrochemical impedance spectra (EIS) plots of a FeS₂|SE|Na battery after the 1^{st} and after the 1,000^{th} cycle, where SE is Na₃SbS₃Se synthesized according to multiple embodiments and alternatives.

FIG. 7C provides the equivalent circuit for the FeS₂|SE|Na battery of FIG. 7B.

FIG. 7D shows charge-discharge profiles of the FeS₂|SE|Na cell presented in FIG. 7A cycling under 50 mAh g⁻¹ at the 100^{th}, 200^{th}, 600^{th}, 800^{th}, 1000^{th} cycles, respectively.

FIG. 7E provides a graph of cycling performance of a FeS₂|SE|Na battery up to 1000 cycles (50 mA g⁻¹) at room temperature, where SE is Na₃SbS₃Se synthesized according to multiple embodiments and alternatives.

FIG. 8A shows XRD patterns of xNaF·(1−x) NSS samples synthesized according to multiple embodiments and alternatives.

FIG. 8B shows an enlarged area of FIG. 8A between 2θ 34° and 40°.

FIG. 8C shows XRD patterns for pristine NSS, 0.1F-NSS, 0.1Cl—NSS, 0.1Br—NSS, and 0.1I—NSS samples synthesized at 150° C. and 10⁻³ torr.

FIG. 9 displays Raman spectra of xNaF·(1−x) NSS samples synthesized according to multiple embodiments and alternatives.

FIG. 10A is an SEM image of a 0.1F—NSS sample synthesized according to multiple embodiments and alternatives.

FIG. 10B shows EDS mapping of Na, Sb, S, F in a 0.1F—NSS sample synthesized according to multiple embodiments and alternatives.

FIG. 11A graphs ionic conductivities for several xNaF·(1−x) NSS conductors synthesized at room temperature prior to post-heating treatment, according to multiple embodiments and alternatives.

FIG. 11B graphs ionic conductivities for several 0.1X·NSS conductors (X=F, Cl, Br, I) synthesized at 150° C. and 10⁻³ torr.

FIG. 12A and FIG. 12B show TEM images at different magnifications of a 0.1F—NSS powder sample synthesized at room temperature prior to post-heating treatment, according to multiple embodiments and alternatives.

FIG. 12C shows a scanning TEM (STEM) image of the sample of FIG. 12A.

FIG. 12D shows EDS mapping of S, Sb, and F elements corresponding to the sample in FIG. 12C.

FIG. 12E provides SAED of the sample in FIG. 12A.

FIG. 13A shows XRD patterns for xNaF·(1−x) NSS conductors (x=0.1, 0.2, and 0.3) synthesized without post-heating and with post-heating at 300° C. according to multiple embodiments and alternatives.

FIG. 13B and FIG. 13C show enlarged areas I and II, respectively, from FIG. 13A.

FIG. 14A provides a STEM image for a 0.1F—NSS conductor synthesized and post-heated at 300° C. according to multiple embodiments and alternatives.

FIG. 14B shows EDS mapping of S, Sb, and F elements corresponding to the conductor in FIG. 14A.

FIG. 15 graphs XRD refinement results for 0.2F—NSS conductor synthesized and post-heated at 300° C. according to multiple embodiments and alternatives.

FIG. 16 graphs ionic conductivities for several xNaF·(1−x) NSS conductors synthesized and post-heated at 300° C. according to multiple embodiments and alternatives.

FIG. 17A provides results of electrochemical cycling of different symmetric cells using 0.2F—NSS as SE wherein the 0.2F—NSS SE was synthesized and post-heated at 300° C. according to multiple embodiments and alternatives.

FIG. 17B and FIG. 17C show enlarged areas I and II, respectively, from FIG. 17A.

FIG. 17D provides critical current density (CCD) testing results for a Na-Sn|0.2F-NSS|NaSn cell wherein the 0.2F—NSS SE was synthesized and post-heated at 300° C. according to multiple embodiments and alternatives.

FIG. 18A plots in the ratio of full width at half maximum/d value (FWHM/d) associated with 0.2F—NSS conductor synthesized and post-heated at 300° C. according to multiple embodiments and alternatives.

FIG. 18B graphs NaF peak intensity in accordance with heating treatment time for a xNaF·(1−x) NSS conductor synthesized and post-heated.

### MULTIPLE EMBODIMENTS AND ALTERNATIVES

Embodiments of the present disclosure include methods of synthesizing chalcogenide sodium (Na) ionic conductors having the formula Na₃SbS_{4-y}Se_{y} and halide-doped Na₃SbS₄ ionic conductors. The NSS ionic conductors, i.e., sulfide-type sodium-ion conductors, according to the present inventive methods are formed from sulfide (Na₂S) hydrate, antimony sulfide (Sb₂S₃), sulfur(S) precursors, in addition to sodium-halide (NaX) for halide-doped NSS ionic conductors and selenium (Se) in some embodiments related to chalcogenide sodium (Na) ionic conductors. As further described below, the ionic conductors are useful as SEs and can be used in electrochemical energy storage devices. Present embodiments also include methods of synthesizing halide-doped xNaX·(1−x)Na₃SbS₄ nanocomposites and their use, including nanocomposites where the halide (X) comprises fluorine (F). In some embodiments, the value of y in the subject Na₃SbS_{4-y}Se_{y} sodium chalcogenide conductors exceeds 0 and is no greater than 2. In some embodiments, the subject chalcogenide sodium ionic conductors obtained by practicing the inventive methods exhibit an ionic conductivity at room temperature of at least 2.55×10⁻⁴ S cm⁻¹. In some embodiments, the subject halide-doped NSS ionic conductors obtained by practicing the inventive methods exhibit an ionic conductivity at room temperature of at least 3.8×10⁻⁴ S cm⁻¹, and in some embodiments this value is 4.8×10⁻⁴ S cm⁻¹.

### Synthesis of Chalcogenide Sodium (Na) Ionic Conductors

In an exemplary synthesis, solid powders of sodium sulfide (Na₂S) hydrate, antimony sulfide (Sb₂S₃), sulfur(S), and, optionally, selenium (Se) are grounded and mixed via solvent-free mixing to form intermediate product hydrates formed from solvent-free methods. The purity of these precursor materials in the reactions described herein was Na₂S hydrate (98%), Sb₂S₃ (98%), S (99.99%), and Se (99.0%). Depending on whether Se is used as a partial replacement for S and in accordance with the stoichiometric ratio used, the intermediate products are of the formula Na₃SbS_{4-y}Se_{y} hydrate, where y=0, 1, or 2. In some embodiments, the method involves heating the intermediate product hydrates for up to 3 hours at a temperature between 50° C. and 200° C. In some embodiments, these intermediate product hydrates undergo this heat treatment at 70° C. and 150° C. separately for 1 hour at each temperature under a vacuum of 10⁻³ torr. More broadly, the intermediate product hydrates may be heated at a relatively low temperature between about 50° C. and 200° C., preferably about 150° C.+/−50° C. and more preferably +/−10° C., under low vacuum (10⁻³ torr). This step removes water from the sodium chalcogenide hydrates to produce crystalline sodium chalcogenides having the formula Na₃SbS_{4-y}Se_{y}. In some embodiments, the method produces ionic conductors having a hydrate water content of the crystalline product no greater than 40%.

In an alternative exemplary synthesis, instead of heating the powders, a different step is used on the intermediate Na₃SbS_{y}Se_{4-y} hydrate products after solvent-free mixing of the precursors (i.e., Na₂S hydrate, Sb₂S₃, S, and Se, if used). In this alternative, the intermediate product was loaded in a TEM chamber and kept under high vacuum (10⁻⁶ torr) for 8 hours (i.e., at least 8 hours). Thereafter, the intermediate sample was exposed to a high intensity electron beam (up to 5 kV) for short duration (less than 1 minute) to produce crystalline Na₃SbS_{4-y}Se_{y} chalcogenides.

Accordingly, in some embodiments the chemical reaction for production of chalcogenide sodium conductors can be written as follows:

$$Formula 1$$

$$2 {Na}_{2} S \cdot 9 {H}_{2} O + {Sb}_{2} {S}_{3} + ( 2 - y ) S + y Se {\to }^{RT} 2 {Na}_{3} {SbS}_{4 - y} {Se}_{y} \cdot hydrate {\to }^{heat + l ower vacuum} 2 {Na}_{3} S b {S}_{4 - y} S {e}_{y}$$

And for the alternative exemplary synthesis, Formula 2:

$$2 {Na}_{2} S \cdot 9 {H}_{2} O + {Sb}_{2} {S}_{3} + ( 2 - y ) S + y Se {\to }^{RT} 2 {Na}_{3} {SbS}_{4 - y} {Se}_{y} \cdot hydrate {\to }^{beam + higher vacuum} 2 {Na}_{3} S b {S}_{4 - y} S {e}_{y}$$

### Characterization of Chalcogenide Sodium (Na) Ionic Conductors

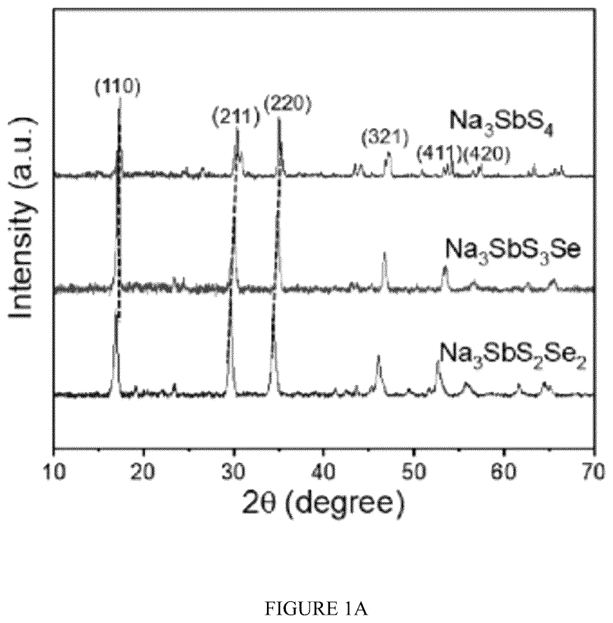

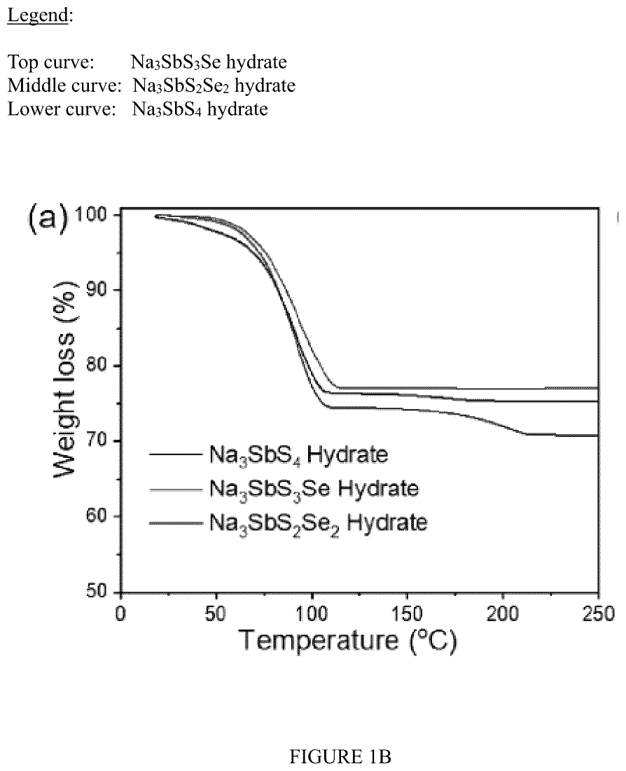

FIG. 1A provides the XRD patterns for the crystalline products obtained after such heating under low vacuum, where y=0, 1, or 2. XRD measurements were performed using a Bruker D8 Discover diffractometer (nickel-filtered Cu Kα radiation, λ=1.5418 Å) in a 2θ range of 10-70° with the samples covered by Kapton films. Comparison of these XRD patterns to those of the precursors confirms that the chemical reaction of Formula 1 occurred. This also corresponds with expectations about the removal of hydrate water with respect to these intermediates. For example, FIG. 1B shows the TGA curves for the Na₃SbS_{4-y}Se_{y} intermediate hydrates (y=0, 1, 2). All three showed a weight loss at about 100° C., corresponding to the removal of hydrate water to produce crystalline Na₃SbS_{4-y}Se_{y} chalcogenides. For Na₃SbS₄, there is an additional minor weight loss at about 210° C., wherein the second weight loss at the higher temperature is possibly associated with the loss of sulfur to form Na₃SbS₃. Accordingly, in some embodiments, these Na₃SbS_{4-y}Se_{y} intermediate hydrates form crystalline Na₃SbS_{4-y}Se_{y} chalcogenides when heated to a temperature of 60° C. to no greater than about 200° C., preferably about 150° C.

Further, the split peaks in Na₃SbS₄ (y=0, top curve) corresponding to the planes (211) (2θ=) 30.2/30.5° and (220)(2θ=35.1/35.4°), respectively, indicates the tetragonal structure of Na₃SbS₄ (space group F43m). By comparison, with higher Se content, the Na₃SbS₃Se and Na₃SbS₂Se₂ samples both displayed symmetric diffraction peaks at these planes and downshift (i.e., increased d-spacing values), which are indexed to cubic structure (space group P421c). The larger atomic size of Se²⁻ than S²⁻ resulted in a slight increase in lattice parameters for the Se-substituted form. Further, the XRD patterns seen with increasing Se doping content of the Na₃SbS_{4-y}Se_{y} chalcogenides conforms generally with Na₃SbS_{y}Se_{4-y} conductors obtained from solid-state reaction methods that utilize higher temperatures (450° C.-800° C.) and/or ball-milling treatment.

The images in FIG. 2 show SAED patterns for Na₃SbS₄ and Na₃SbS₃Se, respectively, as formed from this alternative method (i.e., Na₃SbS_{4-y}Se_{y} where y=0 and 1, respectively). In this figure, panels (a)-(c) are of Na₃SbS₄, and panels (d)-(f) are of Na₃SbS₃Se. The ring patterns corresponding to planes of (110), (211) and (220) are marked in panels (a) and (d). The SAED patterns correspond with electron-beam assisted treatment at room temperature (RT) in panels (a) and (d) for Na₃SbS₄ and Na₃SbS₃Se, respectively, compared to electron-beam assisted treatment accompanied by heat treatment at 100° C. in panels (b) and (e), respectively, and at 200° C. in panels (c) and (f), respectively. The well defined patterns shown on SAED indicate the crystalline form of these products compared to the intermediates obtained from mixing. Further, the observation in panels (a) and (d), respectively, show that crystalline Na₃SbS₄ and Na₃SbS₃Se were synthesized under electron-beam and high vacuum at RT without adding heating treatment, although the ring-patterns exhibited at 100° C. and 200° C. are stronger, indicating higher crystallinity at these temperatures.

In other studies, it was observed that when an intermediate Na₃SbS_{y}Se_{4-y} hydrate (i.e., Na₃SbS₃Se) formed by solvent-free mixing was subjected to high vacuum (10⁻⁶ torr) for an extended period of 48 hours at room temperature (no heating), XRD studies showed the main diffraction patterns for Na₃SbS₃Se, while several impurity peaks also were present in addition to the main diffraction peaks. The impurity phase in present in this high-vacuum treated sample was reflected by lower ionic conductivity as determined by EIS, suggesting that for this alternative, both electron-beam and high vacuum play important roles in obtaining the crystalline forms of these Na₃SbS_{y}Se_{4-y} chalcogenides. Therefore, to obtain the pure phase, either extended vacuum time is needed or both the energy source (e.g., electron beam or laser) and high vacuum are required in a relatively shorter time.

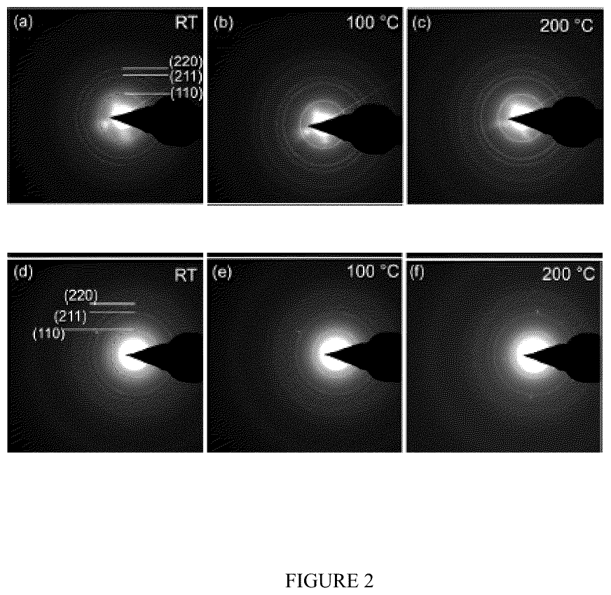

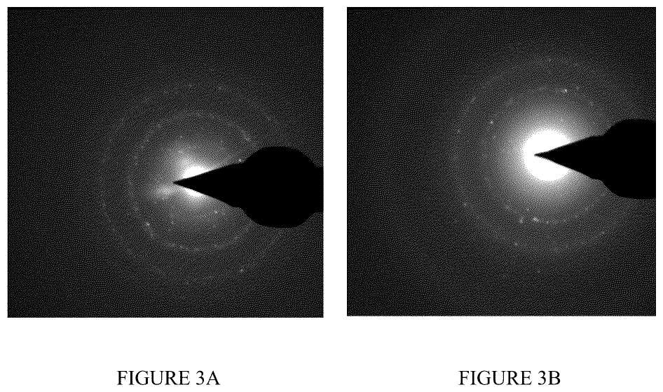

In still other SAED studies, it was observed that when electron-beam assisted synthesis was used and the heating temperature was increased to 400° C., the ring diffractions became more blurry. FIG. 3A shows results of SAED of Na₃SbS₄ 400° C., and FIG. 3B shows results of SAED of Na₃SbS₃Se at the same temperature. The results may indicate a disordering of the crystalline structure of these Na₃SbS_{4-y}Se_{y} chalcogenides as the temperature approaches the melting temperature of about 550° C.

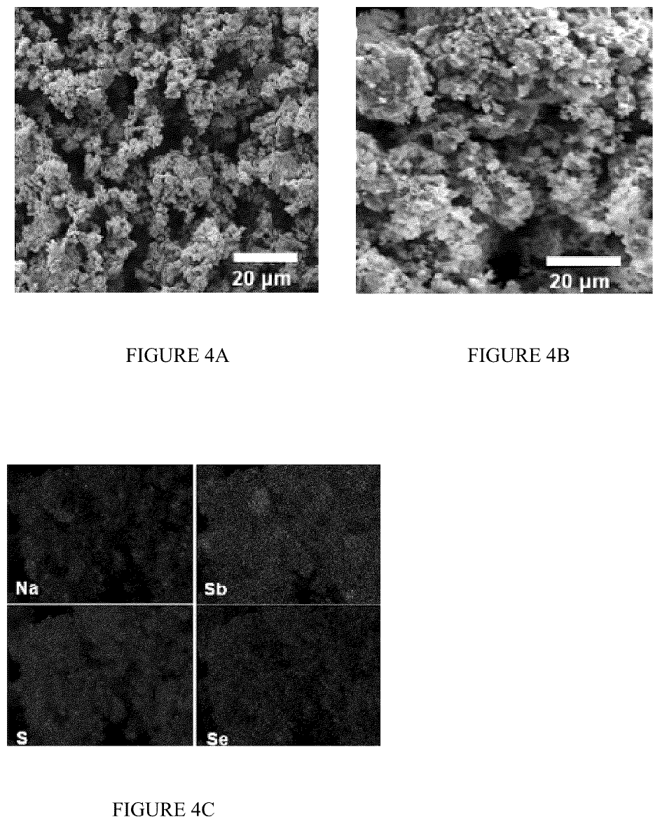

FIGS. 4A-7E involve characterization following synthesis using a solvent-free, low temperature (150° C.), low vacuum (10⁻³ torr) method as described herein according to multiple embodiments. SEM images (SEM, TESCAN Vega3 with energy dispersive x-ray spectroscopy) of synthesis products obtained according to the embodiments herein showed characteristic morphologies of Na₃SbS₄ (FIG. 4A) and Na₃SbS₃Se (FIG. 4B), respectively. For Na₃SbS₃Se, separate EDS mapping (FIG. 4C) confirmed the Se elemental distribution existent in the Na₃SbS₃Se particles.

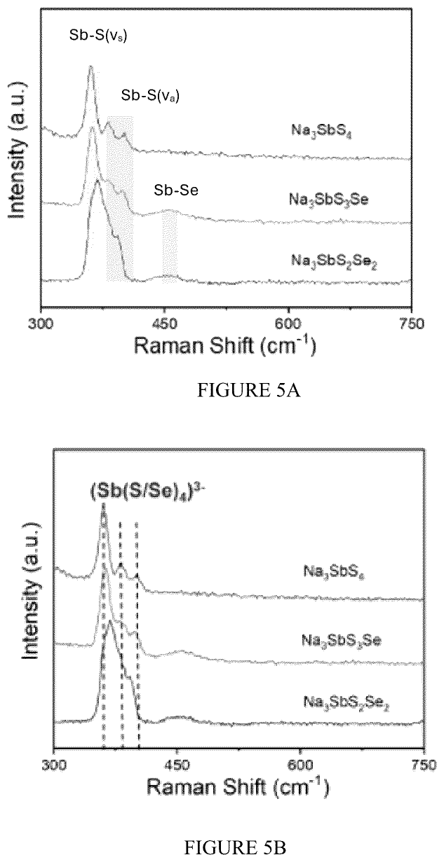

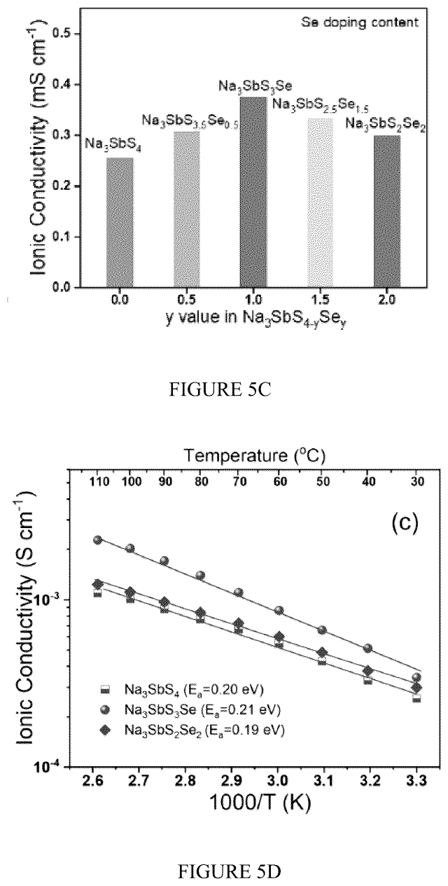

FIG. 5A displays Raman spectra of Na₃SbS_{4-y}Se_{y} chalcogenides (y=0, 1, 2) synthesized according to present embodiments. Raman scattering measurements were carried out by a Renishaw in Via Raman/PL Microscope with a 632.8 nm laser. For Na₃SbS₄, the presence of (SbS₄)³⁻ group is confirmed by the representative peaks at 361 cm⁻¹ and 382/402 cm⁻¹. The figure indicates symmetric vibration (vₛ) of the Sb—S bond along with asymmetric vibration (v_{α}), respectively. By comparison, for Na₃SbS₃Se and Na₃SbS₂Se₂ (middle and lower curves in the figure, respectively) the vₛ peak at 361 cm⁻¹ remains strong but slightly red-shifts, while in both cases after introducing the Se dopant, the v_{α} peak appearing at 382/402 cm⁻¹ denoted in the figure by the region marked as “Sb—S(v_{α})” weakens and merges into a single peak. This observation is consistent with the Se doping induced phase transition from tetragonal (F43m) to cubic (P421c) structure in XRD results. Additionally, FIG. 5B shows the Raman peaks of (Sb(S/Se)₄)³⁻ shift to the right as Y increases from 0 to 1 to 2 and merge into a single peak. This observation is consistent with the Se doping induced phase transition from tetragonal (Space Group: P4̅2₁C (number: 114)) to cubic (Space Group: I4̅3m (number: 217)) structure in XRD results. Additionally, FIG. 5B shows the Raman peaks of (Sb(S/Se)₄)³⁻ shift to the right as Y increases from 0 to 1 to 2 and merge into a single peak.

FIG. 5C graphs the ionic conductivities at room temperature as determined for several Na₃SbS_{4-y}Se_{y} chalcogenides (y=0, 0.5, 1, 1.5, 2) that were synthesized. At first, the RT ionic conductivity of each sample increased as Se doping content increased. More specifically, the as-synthesized Na₃SbS₄ obtained from the inventive solvent-less and low-temperature approach of current embodiments had an ionic conductivity of 2.55×10⁻⁴ S cm⁻¹ at room temperature. After introducing Se, the ionic conductivity of Na₃SbS_{4-y}Se_{y} first increased to a value of 3.75×10⁻⁴ S cm⁻¹ for Na₃SbS₃Se after synthesis at 150° C. Then beyond y=1, ionic conductivity slightly decreased with greater Se content (i.e., the bars in the graph moving from left to right in FIG. 5C) reaching 3.01×10⁻⁴ S cm⁻¹ for Na₃SbS₂Se₂.

The linear Arrhenius plots shown in FIG. 5D graph ionic conductivity as a function of temperature for the Na₃SbS_{4-y}Se_{y} chalcogenides (y=0, 1, 2). Arrhenius plots were obtained by temperature dependent EIS measurements from 30 to 110° C. with an interval of 10° C. From these plots, the activation energies (E_{α}) can be estimated using the equation of σ=Aexp(−E_{α}/k_{b}T), where E_{α} is the activation energy, σ is ionic conductivity, T is the temperature (K), A is the pre-exponential factor, and k_{b} is the Boltzmann constant. Of the three values listed, the E_{α} of Na₃SbS₂Se₂ (0.19 eV) is lower than that of tetragonal-Na₃SbS₄ (0.20 eV) but much higher than cubic Na₃SbS₄ and W-doped Na₃SbS₄.

Further characterizing the Na₃SbS_{4-y}Se_{y} (x=0, 1, 2) chalcogenides, as shown in FIG. 5E, the Nyquist plots at room temperature showed impedance values that followed a trend of Na₃SbS₃Se<Na₃SbS₂Se₂<Na₃SbS₄.

### Performance of Chalcogenide Sodium (Na) Ionic Conductors

Na₃SbS_{4-y}Se_{y} (x=0, 1) chalcogenides were synthesized and used as SEs in Na|SE|Na symmetric cells, where SE is Na₃SbS₄ and Na₃SbS₃Se. For the symmetric cell assembly, each pellet was sandwiched by two pieces of Na foils and loaded into 2032-coin cell (no external pressure), with a trace amount (˜5 μL) ionic liquid (NaTFSI in PYR14TFSI) added at both the cathodic and anodic interface for better wetting and to reduce the solid/solid contact resistance. Galvanostatic cycling performed on a Bio-Logic VSP300 potentiostat. In addition, solid state Na|Na₃SbS₃Se|FeS₂ batteries also were assembled. For the preparation of cathode, FeS₂ powder, Super P and PVDF binder (weight ratio of 6:2:2) were mixed with N-methyl pyrrolidone (NMP) as the solvent to form a homogeneous slurry. Then, the slurry was cast on aluminum foil, dried at 80° C. for 24 h, and the mass loading of active material was performed around 1.0-1.5 mg cm⁻².

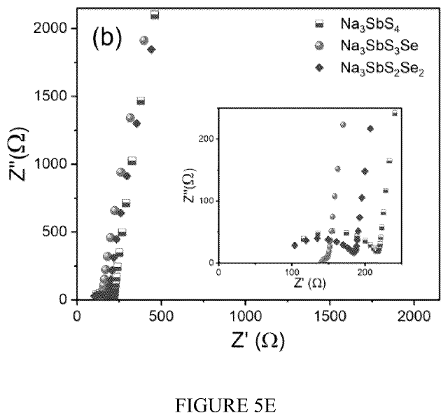

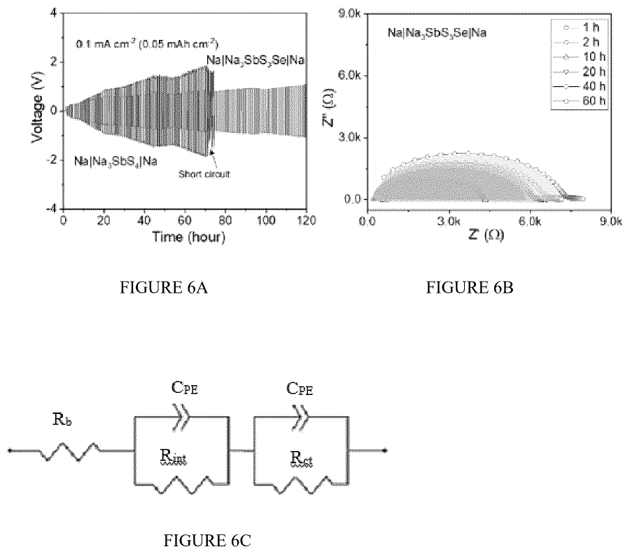

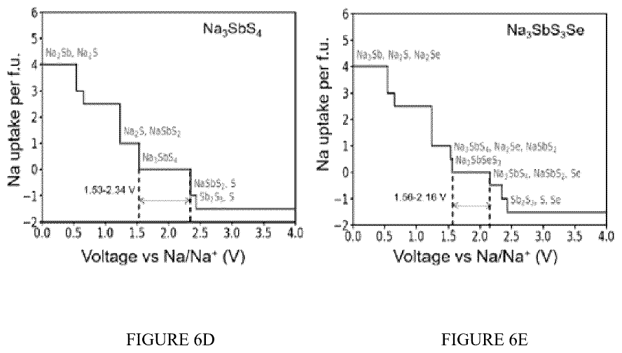

FIG. 6A indicates differences in interfacial compatibility between the two SEs based on polarization voltage profiles under a current density of 0.1 mA cm⁻². The cell with pristine Na₃SbS₄ SE exhibited an overpotential which rose quickly as cycling proceeded then underwent a sudden drop around 70 hrs, suggesting a short-circuit with the unstable interface between Na and Na₃SbS₄, likely due to the continuous interfacial reactions. By comparison, the cell with Na₃SbS₃Se as SE showed an initial increase on the overpotential then stabilized after extended cycling to 100 hrs, according to the symmetric cell impedance spectra shown in FIG. 6A, with slight increase in resistance after 20 cycles.

In FIG. 6B, Nyquist plots are provided of the Na|Na₃SbS₃Se|Na cell of FIG. 6A after cycling over different time frames (1 h, 2 h, 10 h, 20 h, 40 h, 60 h), respectively. The symmetric cell impedance spectra over time are shown in FIG. 5C, where the resistance slightly increases after 20 cycles. This comparison further indicates that Se-doping benefits the electrochemical stability of Na₃SbS₄, leading to enhanced interface stability of Na₃SbS₃Se towards Na metal.

FIG. 6C shows the equivalent circuit for the Na|Na₃SbS₃Se|Na cell of FIG. 6B. In this Figure, Rb represents the bulk resistance, and Rᵢₙₜ represents the solid electrolyte interface resistance, and Rat represents the charge transfer resistance between the Na electrode and SE.

In FIG. 6D and FIG. 6E, respectively, density functional theory (DFT) calculations were employed to assess phase equilibria at Na|Na₃SbS₄ and Na|Na₃SbS₃Se interfaces using the grand potential phase diagram approach. These figures show the electrochemical reaction products of Na₃SbS₄ (FIG. 6D) and Na₃SbS₃Se (FIG. 6E) at different potentials. The calculated Na grand potential phase stability plot of Na₃SbS₄ was consistent with prior theoretical and experimental works, and the predicted electrochemical stability windows (ESWs) for the two SEs were close to each other (Na₃SbS₄: 1.53-2.34 V; Na₃SbS₃Se: 1.56-2.16 V). The ESW of Na₃SbS₃Se was marginally smaller due to the existence of Na₃SbS₄ in the short windows on the anodic ends. (1.53 in FIG. 6D as compared to 1.56 V in FIG. 6E) and cathodic (2.34 in FIG. 6D as compared to 2.16 V in in FIG. 6E). Significantly, the DFT calculations show that at the Na/SE interface, both SEs decompose into a combination of metallic (Na₃Sb) and insulating products (Na₃SbS₄: Na₂S for FIG. 6D; Na₃SbS₃Se: Na₃Sb and Na₂Se).

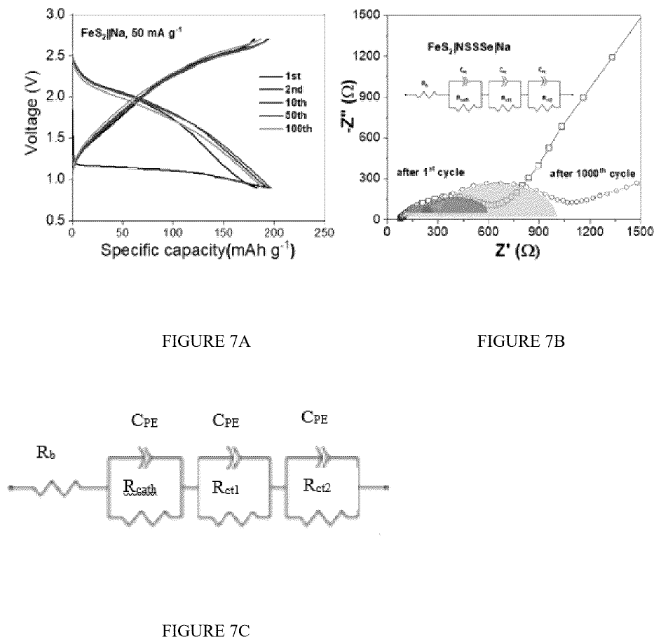

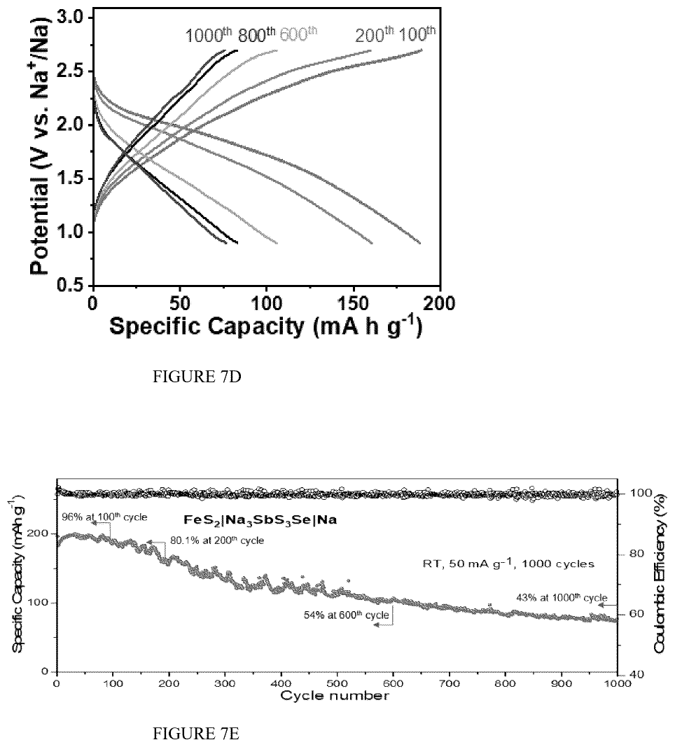

FIG. 7A shows charge-discharge profiles of a FeS₂| Na₃SbS₃Se|Na over 100 cycles at 50 mA g⁻¹. The solid-state battery was cycled between 1.0 and 2.7 V at RT, and the 1st, 2nd, 10th, 50th and 100th cycles are shown in the profiles. The cut-off voltage at 1.0 V was intended for the intercalation reaction by taking two Na⁺ per formula units of pyrite FeS₂ to enhance the cyclability. Under a current density of 50 mAh g⁻¹, the battery exhibited a flat discharge plateau at 1.2 V and achieved an initial specific discharge capacity of 198 mAh g⁻¹. In the subsequent cycles, the battery showed higher potentials and relatively stable specific capacity between 190-200 mAh g⁻¹ and capacity retention of 96% for the initial 100 cycles.

FIG. 7B shows EIS plots after the 1^{st} and after the 1,000^{th} cycles obtained using a multichannel potentiostat (Bio-logic VSP300) at the frequency range from 5 MHz to 100 MHz applying a 10-mV voltage amplitude of the FeS₂| Na₃SbS₃Se|Na battery from FIG. 7A. Ionic conductivity measurements described herein were calculated based on the equation:

$$σ = L / R \cdot A$$

where L (cm) and A (cm²) are the thickness and the area of the SE pellet, respectively, and R (Ω) is its resistance from Nyquist plots. FIG. 7B indicates resistance values at these points of 590Ω and 1,100Ω, respectively.

FIG. 7C provides the equivalent circuit for the FeS₂|SE|Na battery of FIG. 7B, where Rb represents the bulk resistance, R_{cath} represents the resistance in the FeS₂ cathode, Rct₁ represents the interface resistance between the SE and cathode, and Rct₂ represent the interface resistance between the SE and Na anode.

The charge-discharge profiles shown in FIG. 7D graph potential (V vs. Na⁺/Na) over specific capacity (mAh g⁻¹) for the cell, with results of cycling shown for the 100th, 200th, 600th, 800th, 1000th cycles, respectively.

In FIG. 7E, repeated cycling of the Na|Na₃SbS₃Se|FeS₂ battery for 1,000 cycles, under a current density of 50 mAh g⁻¹, showed that the cell had a 96% retained specific capacity at the 100^{th} cycle, and further retained a specific capacity of 160 mAh g⁻¹ at the 200th cycle and 105 mAh g⁻¹ at the 600th cycle, with gradual decline through the 1000^{th} cycle.

### Alternative Structures

Embodiments of the present disclosure also include Na chalcogenides of the formula Na₃SbS_{4-y}X_{y}. In some embodiments, X can be a halide chosen from the group consisting of F, Cl, Br, and I. These Na chalcogenides can be formed in accordance with synthesis methods described herein.

In addition to the chalcogenide Na conductors described previously, various xNaX·(1−x) Na₃SbS₄ nanocomposite conductors were synthesized and post-treated with heating, in accordance with multiple embodiments and alternatives. These included, but were not limited to, several having the formula xNaF·(1−x)NSS, 0.1≤x≤0.5. The syntheses also utilized post-heating treatment, and the effects of this on structure, morphology, and conductive properties of these conductors are discussed below.

### Synthesis of Halide-Doped NSS Conductors

Halide-doped NSS nanocomposite conductors, including but not limited to xNaF·(1−x) NSS, were synthesized through a solvent-free and low-temperature synthesis method, similar to the low-temperature method described previously for chalcogenide sodium conductors. Briefly, the precursors were sodium sulfide hydrate, antimony sulfide, sulfur, and sodium fluoride. The precursors were first mixed in a stoichiometric ratio, thereafter the mixture underwent further heat treatment at 70° C. and 150° C. separately to obtain products. Several experiments described below were performed on these products, while additional experiments were performed on the as-synthesized xNaF·(1−x) NSS samples by additional heating to 300° C. with 5° C./min and dwell for 2h. For these, the obtained samples are referred to as xNaF·(1−x) NSS (300° C.), and in the exemplary embodiments provided herein x=0.1, 0.2, 0.3, and 0.5.

Accordingly, in some embodiments the chemical reaction for production of halide-incorporated/halide-doped NSS conductors can be written as follows:

$$Formula 3$$

$$1.5 ( 1 - x ) {Na}_{2} S \cdot {y H}_{2} O + 0.5 ( 1 - x ) {Sb}_{2} {S}_{3} + ( 1 - x ) S + x Na X {\to }^{low heat} x Na X \cdot ( 1 - x ) {Na}_{3} S b {S}_{4} + y {H}_{2} O$$

As noted below, the xNaX·(1−x) Na₃SbS₄ products (e.g., xNaF·(1−x) NSS conductors) underwent post-heating treatment at 300° C. by way of exemplary temperature, thereby increasing the crystallinity of the products. In this regard, as used herein halide-incorporated” refers to a composition such as indicated above where a secondary phase (xNaX, which can be xNaF) forms, and “halide-doped” refers to a formed single phase with halogen replacing S in the NSS crystalline structure.

### Characterization of Halide-Doped NSS Conductors

In a set of experiments, a series of xNaF·(1−x) NSS samples (0.1≤x≤0.5) were prepared using the low-temperature synthesis method (T=150° C.) and varying the NaF content. The post-heating treatment occurred at 300° C. for 2 h in an inert environment in an argon (Ar) filled glove box with contents of H₂O, O₂<1 ppm. XRD measurements were performed using a Bruker D8 Discover diffractometer (nickel-filtered Cu Kα radiation, λ=1.5418 Å) in a 2θ range of 10-60° with the samples covered by Kapton films.

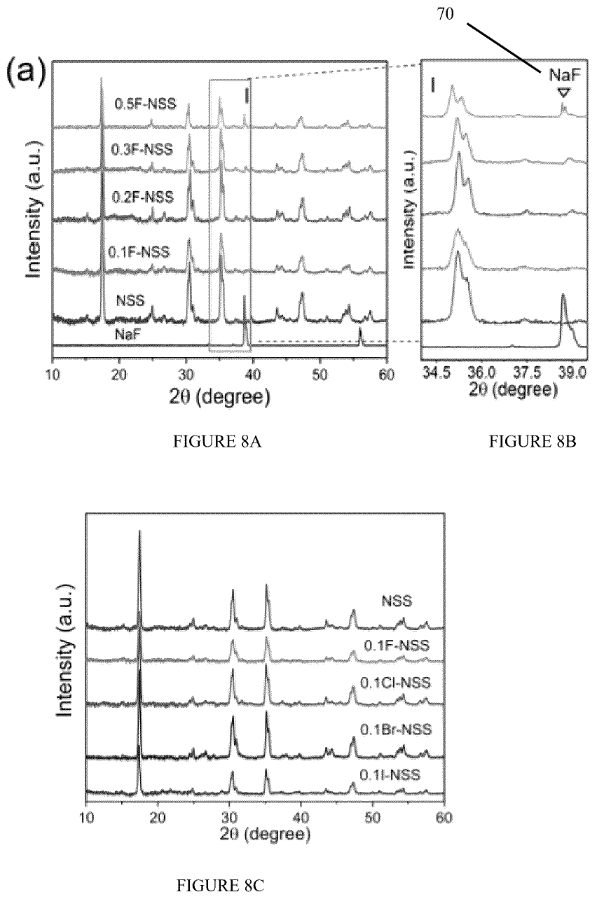

FIG. 8A shows the XRD results performed on the fluorine-incorporated samples and NSS alone (i.e., x=0, 0.1, 0.2, 0.3, 0.5) as well as NaF. The fluorine-containing NSS samples showed dominant diffraction peaks at 17.3°, 30.2°, 35.1° and 47.18°, corresponding to the (110), (211), (220), and (321) planes of a tetragonal structure (space group P-421c) for NSS. Also, the XRD diffraction patterns of NaF shows characteristic diffraction peaks for 2θ=38.7° and 56.1° which do not appear in the sample of 0.1F—NSS. Beyond this, and as further shown in the right-hand portion of FIG. 8B, a minor peak at 2θ=38.7° from NaF (indicated by reference line 70) appears in three samples with higher F-contents (x=0.2, 0.3, 0.5). In addition, XRD refinement results were performed by Rietveld refinement using GSAS-II crystallography and EXPGUI data analysis software. The results indicated that the xNaF·(1−x) NSS samples (x=0.1, 0.2, 0.3) contained 0.93 wt %, 2.9 wt % and 3.3 wt % of NaF, respectively, consistent with the increasing value of x in these samples.

Besides fluorine, other halide-doped NSS (i.e., X=Cl, Br, I) were synthesized following the same process as with fluorine and their crystalline structures were characterized. FIG. 8C shows XRD patterns for pristine NSS, 0.1F—NSS (i.e., 0.1NaF·0.9NSS), 0.1Cl—NSS, 0.1Br—NSS, and 0.1I—NSS samples, which were synthesized using the solvent-free, low temperature (150° C.), low vacuum (10⁻³ torr) method described herein. The XRD results performed on these samples showed characteristic diffraction peaks of tetragonal structure without a clear peak for the halide phase (e.g., NaCl, NaBr, NaI), again due to the low amount (x=0.1) of halide content in these samples. It is expected that as x were increased for these NSS conductors, the NaX content would be more evident as with NaF as best seen in FIG. 8B.

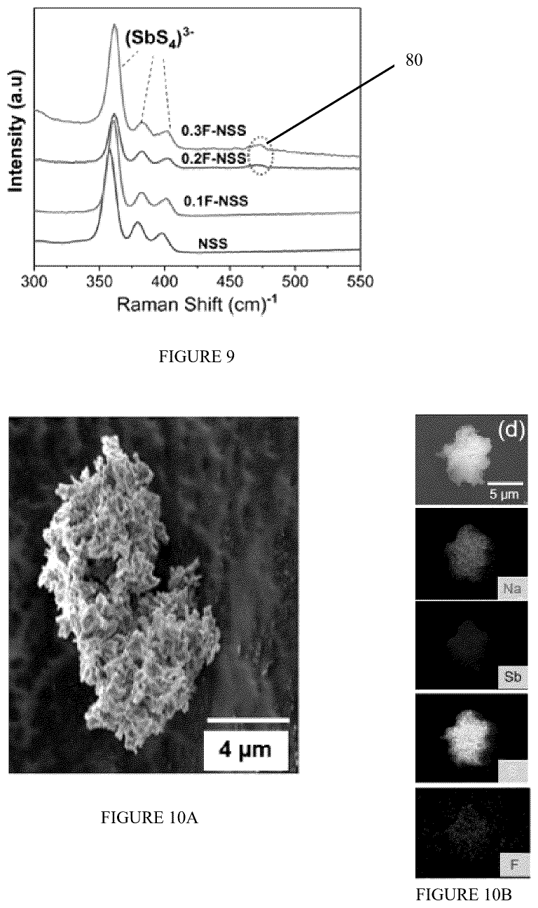

FIG. 9 displays the Raman spectra of xNaF·(1−x) NSS samples (x=0.1, 0.2, 0.3) from low-temperature synthesis as compared with pristine NSS, using an in Via Raman/PL Microscope with 632.8 nm laser. Notably, strong peaks at 358-360, 380-382 and 400-402 cm⁻¹ are observed in all samples, associated with the characteristic asymmetric (Vα) and symmetric (Vs) stretching vibration of the SbS₄⁻³ group. Additionally, a new peak at around 475 cm⁻¹ appears for the x=0.2 and 0.3 samples, respectively, as indicated by oval 80. This peak became stronger with increasing F-content from x=0.2 to x=0.3, suggesting that this peak originated from the introduction of fluorine. In Raman spectra performed on other samples (not shown), a similar trend was observed in the case of NaI—Na₃SbS₄ conductors.

Now turning to morphology, FIG. 10A displays a SEM image of the 0.1F—NSS powder with granular morphology and particle size of 4-10 μm (secondary particle size at sub-micrometer). Similar granular morphologies appear in the SEM images (not shown) for other samples with higher F-contents (x=0.2, 0.3, 0.5). The EDS mapping of 0.1F—NSS FIG. 10B for Na, Sb, and S show homogeneous distribution of the elements for the 0.1F—NSS, albeit the weaker intensity of F is attributed to its lower concentration and its nature as a light element.

FIG. 11A graphs the EIS measurements of ionic conductivities at room temperature for xNaF·(1−x) NSS (0.1≤x≤0.5) samples from the low-temperature synthesis approach (T=150° C.) without post-heating treatment. This figure shows a 0.1F—NSS sample with the highest ionic conductivity of 2.8×10⁴ S cm⁻¹ among different compositions, leading to 10% increase compared to pristine NSS (2.5×10⁻⁴ S cm⁻¹). After increasing F-content, the ionic conductivity of 0.2F—NSS sample slightly decreases to 2.3×10⁻⁴ S cm⁻¹, and continuously drops for other F-doped NSS. The 0.5F—NSS sample displayed the lowest ionic conductivity of 1.6×10⁻⁴ S cm⁻¹ at room temperature, which is possibly due to the increased amount of secondary NaF phase. In addition, FIG. 11B graphs EIS measurements of ionic conductivities at room temperature for several 0.1X—NSS conductors (i.e., 0.1NaX·0.9NSS where X=F, Cl, Br, I) synthesized at 150° C. and 10⁻³ torr, with 0.1NaF-0.9NSS as highest at approximately 2.8×10⁻⁴ S cm⁻¹. In comparison, 0.1Cl—NSS and 0.1Br—NSS showed similar ionic conductivity of 1.5×10⁻⁴ S cm⁻¹, and 1.4×10⁻⁴ S cm⁻¹, while the ionic conductivity of 0.1I—NSS showed the lowest value of the three (1.1×10⁻⁴ S cm⁻¹).

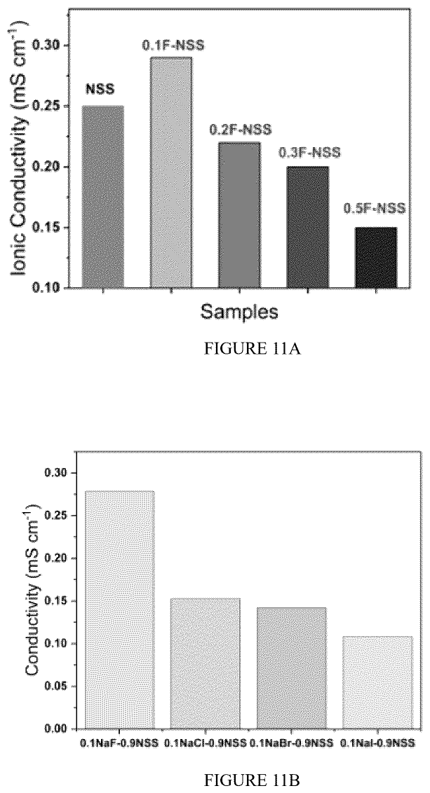

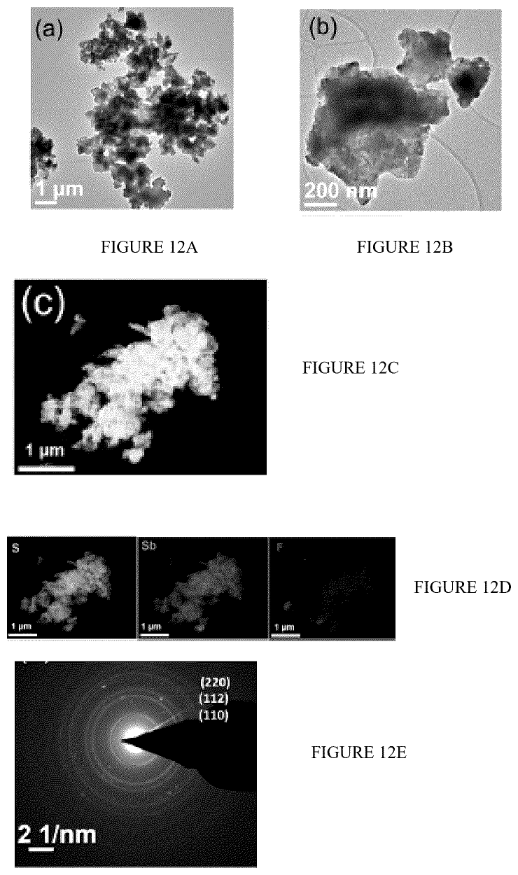

FIGS. 12A and 12B display TEM images of 0.1F—NSS powder sample, which shows the particle size between 100 nanometers to sub-micrometer, respectively. An additional image obtained from high-angle annual dark-field (HAADF) scanning TEM (STEM) is shown in FIG. 12C. On elemental mapping depicted in FIG. 12D, the distribution of sulfur(S) and antimony (Sb) were homogeneous, whereas fluorine (F) exhibited partial aggregation in local areas due to the secondary phase of NaF. As further characterization, the SAED pattern in FIG. 12E shows multiple diffraction spots together with ring patterns (e.g., planes of (110), (112), (220)), indicating the co-existence of NaF phase and NSS structure, consistent with the EDS and XRD refinement results. The TEM and SAED findings described herein were obtained using a 200 kV FEI Tecnai F20 transmission electron microscope.

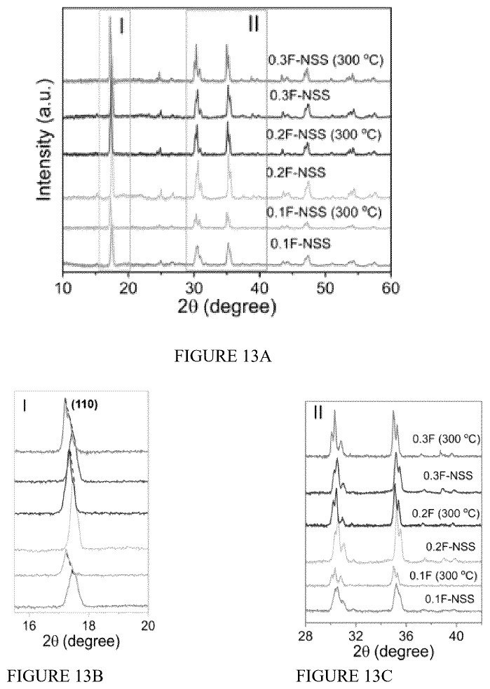

Turning now to characterizing the effects of post-heating treatment, FIG. 13A-C compares the XRD patterns of xNaF·(1−x) NSS samples (x=0.1, 0.2, and 0.3) before and after 300° C. post-heating treatment. As shown in the enlarged I area depicted in FIG. 13B, all samples display a left shift of the strongest (110) plane after post-heating treatment at 300° C., reflecting the increased lattice parameters. For 0.2F—NSS sample as an example, its lattice parameters change from a=b=7.159 Å, c=7.284 Å (before) to a=b=7.164 Å, c=7.287 Å (after 300° C.), respectively. Moreover, the post-heating treatment also results in the decrease of diffraction peaks for NaF phase, as shown in the enlarged area II shown in FIG. 13C.

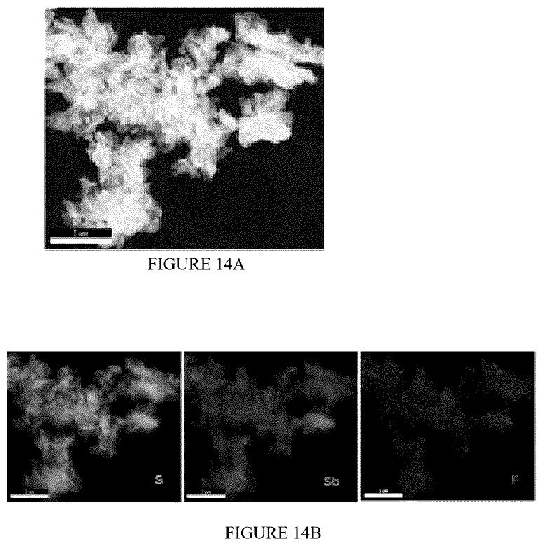

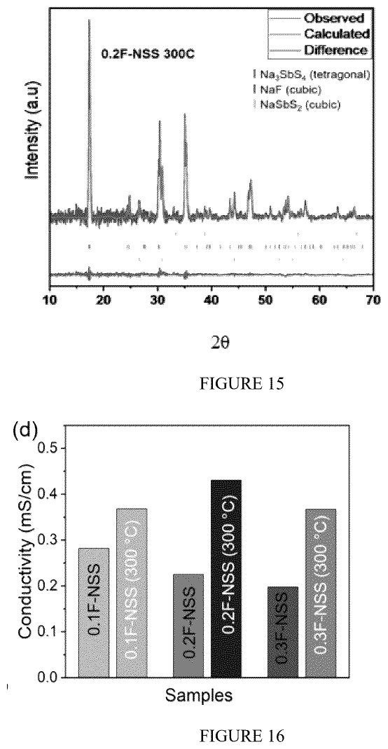

FIG. 14A displays a STEM image scaled to 1 μm for 0.1F—NSS after post-heating treatment at 300° C., and FIG. 14B shows corresponding EDS maps for S, Sb, and F elements. A more homogeneous distribution for the F element suggests NaF phase content was lower due to incorporation of F into the NSS crystal lattice structure during the post-heating treatment, which increases the concentration of Na vacancies and consequently enhances ionic conductivity. Additionally, XRD refinement results shown in FIG. 15 further confirm this observation. Rietveld refinement was performed on the diffraction pattern of the x=0.2 sample from FIG. 13A, using GSAS and EXPGUI software. The figure shows the content of NaF phase was reduced from 2.9 wt % for the as-synthesized sample to 2.58 wt % for the 0.2F—NSS after 300° C. post-heating treatment, again indicating that the post-heating treatment contributed to the incorporation of F into the NSS crystal structure.

By way of comparing different amounts of halide with and without post-heating treatment, FIG. 16 displays the ionic conductivity of xNaF·(1−x) NSS (x=0.1, 0.2, and 0.3) before and after 300° C. post-heating treatment. Here, the 0.2F—NSS (300° C.) sample exhibits the highest room temperature ionic conductivity of 4.8×10⁻⁴ S cm⁻¹, indicating that post-heating treatment (300° C.) enhances crystallization and facilitates higher ionic conductivity for xNaF·(1−x) NSS samples and other halide-doped samples. The 0.1NaF·0.9NSS showed an ionic conductivity of 2.8×10⁻⁴ S cm⁻¹, and 300° C. post-heating treatment increased it to 3.8×10⁻⁴ S cm⁻¹. Notably, all compositions showed some demonstrable increase in their ionic conductivity after the post-heating treatment.

### Performance of Halide-Doped NSS Conductors

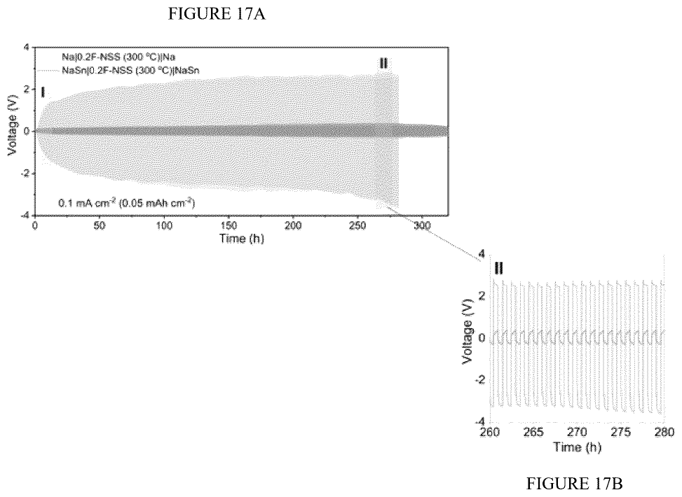

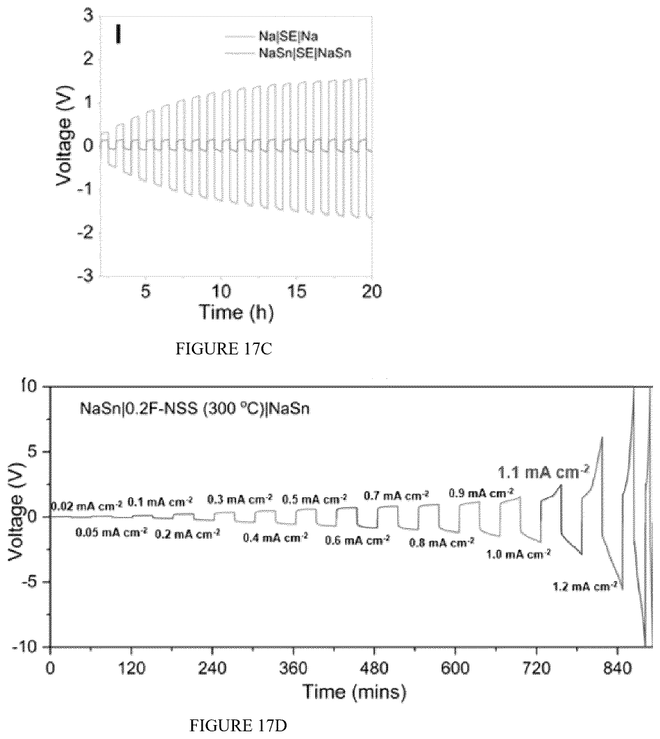

For testing electrochemical stability, 0.2F—NSS after 300° C. post-heating treatment sample was selected to assemble symmetric cells for testing. FIG. 17A presents the voltage profiles for symmetric cells when using Na metal or Na₂Sn alloy as the electrode. By comparison, pure NSS has been reported to show interfacial reaction towards Na metal, causing a fast decay after repeated Na stripping/platting for several hours. However, for the 0.2F—NSS (300° C.) sample (which underwent post-heating treatment following synthesis), as shown in FIG. 17C, an enlarged portion of FIG. 17A, the voltage rose quickly in the initial few cycles due to the interfacial reactions between F-doped NSS and Na metal. Then as cycling proceeded, as shown in FIG. 17B (again, an enlarged portion of FIG. 17A), the cell displayed a stable cycling performance with a polarization voltage stabilized at around 2 V up to 280 h under a current density of 0.1 mA cm⁻², suggesting the increased stability for F-doped NSS sample. When using Na₂Sn as the electrode (enlarged I and II), the polarization voltage is stable at the beginning without increasing as the cycling proceeds, suggesting the decreased interfacial reactions reported with pure NSS. Moreover, the demonstrably reduced polarization (<0.35 V) and stable cycling performance to 300 h in FIGS. 17A-C indicate more interface stability between the 0.2F—NSS (300° C.) sample and Na₂Sn alloy than towards Na metal, a finding comparable with other halide-doped NSS, such as Na_{2.95}SbS_{3.95}Cl_{0.05}, and Na₃₋ₓSbS₄₋ₓBrₓ.

FIG. 17D shows results of CCD testing performed for 0.2F—NSS (300° C.) conductors in Na₂Sn symmetric cells at room temperature to charge/discharge for 0.5 h and then every 0.1 mA cm⁻² to the full interval (with an area capacity of 0.05 mAh cm⁻²). The polarization voltage values are relatively small at lower current densities (0.02-0.2 mA cm⁻²), and they continuously increase as current densities increase. The CCD value was estimated to be 1.1 mA cm⁻² for the 0.2F—NSS (300° C.) sample towards the Na₂Sn anode, which is close to Na_{2.85}SbS_{3.85}Br_{0.15} (1.4 mA cm⁻²) synthesized under harsh conditions from solid-state reaction (20 h of ball milling and 600° C.).

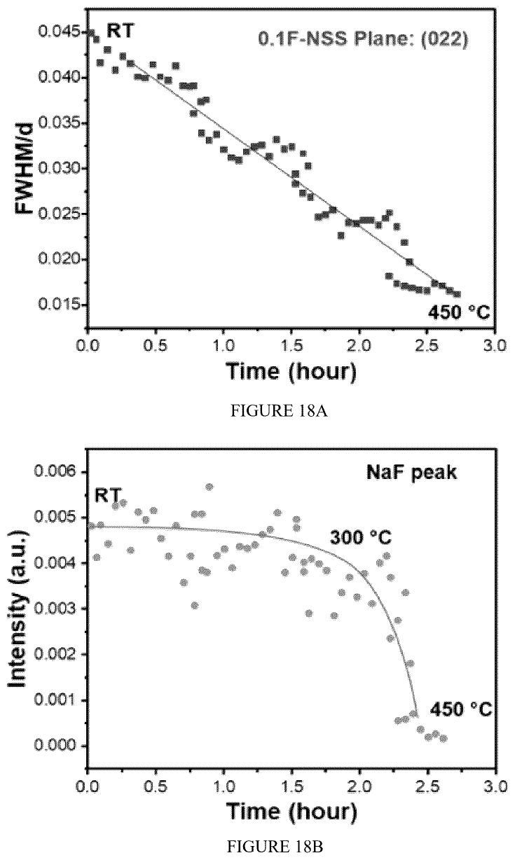

FIG. 18A characterizes a continuous decreasing trend in the ratio of full width at half maximum to d value (FWHM/d). In turn, FIG. 18B graphs the variation of NaF peak intensity with heating treatment time. The trend shows a slight decrease in intensity with increasing temperature, followed by a sudden drop when the temperature exceeds 300° C. After dwell at 450° C. with subsequent cooling down, the diffraction peaks shift to the left, corresponding to a decrease in d-spacing, and also suggesting certain limits on the range at which post-heating treatment benefits the performance of these ionic conductors.

All descriptions herein, including those found in Appendices which are incorporated by reference, are meant to illustrate, rather than to serve as limits on the scope of what has been disclosed herein.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways. Also, it is to be understood that words and phrases used herein are for the purpose of description and should not be regarded as limiting. The use herein of such words and phrases as “such as,” “comprising,” “e.g.,” “containing,” or “having” and variations of those words is meant to encompass the items listed thereafter, and equivalents of those, as well as additional items. The use of “including” (or, “include,” etc.) should be interpreted as “including but not limited to.”

All descriptions herein, including those incorporated by reference, are meant to illustrate, rather than to serve as limits on the scope of what has been disclosed herein. It will be understood by those having ordinary skill in the art that modifications and variations of these embodiments are reasonably possible in light of the above teachings and descriptions.

What is claimed is:

1. A method for synthesizing an NSS ionic conductor for use as a solid electrolyte, comprising:
mixing without solvent a group of precursors comprising sodium sulfide (Na₂S) hydrate, an antimony source, and a sulfur source each at a molar ratio greater than zero and a dopant at a molar ratio of zero or greater to form an intermediate product hydrate; and
after mixing, removing hydrate water from the intermediate product hydrate using at least one of added energy or vacuum to form a crystalline product.

2. The method of claim 1, wherein the antimony source is antimony sulfide (Sb₂S₃) and the sulfur source is sulfur(S), and wherein the hydrate water content of the crystalline product is no greater than 40 wt %.

3. The method of claim 2, wherein the dopant is selenium (Se) and the formula of the NSS ionic conductor is Na₃SbS_{4-y}Se_{y} wherein y is between 0 and 2 inclusive of end points.

4. The method of claim 2, wherein the dopant is a halide at a molar ratio greater than zero and wherein the formula of the NSS ionic conductor is xNaX·(1−x)Na₃SbS₄ wherein x is between 0.1 and 0.5.

5. The method of claim 4, wherein the dopant X is chosen from the group consisting of fluorine, chloride, bromide, and iodide.

6. The method of claim 2, wherein hydrate water removal comprises applying heat to the intermediate product hydrate at a temperature 50° C. to 200° C. under a vacuum up to 10⁻³ torr.

7. The method of claim 6, wherein the temperature is 150° C.+/−10° C.

8. The method of claim 6, wherein applying heat to the intermediate product hydrate comprises applying heat at a first temperature for a time period and applying heat at a second temperature for a time period.

9. The method of claim 8, wherein the time period is up to 3 hours.

10. The method of claim 3, wherein the NSS ionic conductor exhibits an ionic conductivity at room temperature of at least 2.55×10⁻⁴ S cm⁻¹.

11. The method of claim 10, wherein the NSS ionic conductor exhibits an ionic conductivity at room temperature of at least 3.75×10⁻⁴ S cm⁻¹.

12. The method of claim 5, wherein the NSS ionic conductor exhibits an ionic conductivity at room temperature of at least 3.8×10⁻⁴ S cm⁻¹.

13. An electrochemical energy storage device having a structure of anode|SE|cathode, wherein SE is the NSS ionic conductor of claim 3.

14. An electrochemical energy storage device having a structure of anode|SE|cathode, wherein SE is the NSS ionic conductor of claim 5.

15. A method for synthesizing an NSS ionic conductor for use as a solid electrolyte, comprising the steps of claim 1, wherein both added energy and vacuum are used for removing hydrate water from the intermediate product hydrate, wherein the vacuum is 10⁻⁶ torr or less.

16. The method of claim 15, wherein the adding energy comprises applying heat to the intermediate product hydrate at a temperature 50° C. to 200° C. under a vacuum up to 10⁻³ torr.

17. The method of claim 16, wherein the temperature is 150° C.+/−10° C.

18. The method of claim 15, wherein the added energy is focused energy comprising an electron beam or a laser beam.

19. The method of claim 18, wherein the focused energy is an electron beam and wherein the vacuum is between 10⁻³ torr and 10⁻⁶ torr inclusive of the 10⁻⁶ torr end point.

20. The method of claim 19, wherein an intensity of the electron beam is up to 5 kV and the electron beam is applied to the intermediate product hydrate for no greater than 1 minute.

21. The method of claim 1, performed below 50° C., wherein hydrate water removal is performed under vacuum of at least 10⁻⁶ torr.
